(19) United States
(12) Patent Application Publication
(10) Pub. No.: US 2015/0145173 A1
(43) Pub. Date: May 28, 2015

(54) DISCHARGE PLASMA MACHINING DEVICE AND METHOD FOR MANUFACTURING DISCHARGE PLASMA MACHINED PRODUCT

(71) Applicants: MURATA MANUFACTURING CO., LTD., Nagaokakyo-Shi (JP); Kyoto University, Kyoto-shi (JP)

(72) Inventors: Satoru Hachinohe, Nagaokakyo-shi (JP); Osamu Sakai, Kyoto-shi (JP)

(21) Appl. No.: 14/596,517

(22) Filed: Jan. 14, 2015

Related U.S. Application Data
(63) Continuation of application No. PCT/JP2013/057822, filed on Mar. 19, 2013.

(30) Foreign Application Priority Data
Jul. 31, 2012 (JP) 2012-169791

(51) Int. Cl. C04B 35/645

(52) U.S. Cl. CPC C04B 35/645; C04B 2235/602; C04B 2235/667
USPC 264/408; 425/143

(57) ABSTRACT

A discharge plasma machining device that includes punches as a pressing unit for applying a pressure with respect to a machined item, a direct current pulse current generator as a pulse current applying unit for applying a pulse current with respect to the machined item, a spectroscope as a detection unit for detecting a spectrum of light of plasma generated by application of a pulse current, and a control unit for controlling a pulse current in accordance with a detection result of the detection unit.

### CROSS REFERENCE TO RELATED APPLICATIONS

The present application is a continuation of International application No. PCT/JP2013/057822, filed Mar. 19, 2013, which claims priority to Japanese Patent Application No. 2012-169791, filed Jul. 31, 2012, the entire contents of each of which are incorporated herein by reference.

### FIELD OF THE INVENTION

The present invention relates to a discharge plasma machining device and a method for manufacturing a discharge plasma machined product.

### BACKGROUND OF THE INVENTION

Generally, a “discharge plasma machining” is known. The discharge plasma machining is a method of machining a machined item by, in a state where a machined item is arranged between two punches, applying a pulse current between the two punches to raise a temperature of the machined item, and applying a pressure with respect to the same.

Japanese Registered Patent No. 4301761 (PTD 1) discloses that two members are adjoined by the discharge plasma machining. Japanese Patent Laying-Open No. 2000-128648 (PTD 2) discloses that ceramic powder is sintered to obtain a sintered body by the discharge plasma machining. WO2011/089971 (PTD 3) discloses that a semiconductor crystal body is deformed into a desired shape by the discharge plasma machining.

According to the discharge plasma machining based on the conventional art, in a discharge plasma machining device, generally, a temperature is measured by means of a thermocouple provided at a die in which a machined item is arranged, and a control of a pulse current is performed based on a measurement result thereof. Specifically, a pulse current is controlled so that a temperature of a machined item measured by a thermocouple matches with a temperature profile set in a program controller mounted to a discharge plasma machining device. Other than measuring a temperature by means of a thermocouple provided at a die, a method for measuring a temperature of a machined item includes a method of measuring a temperature by means of a thermocouple provided at a punch and a method of measuring a temperature by means of a radiation thermometer. Moreover, other than controlling a pulse current so as to match with a temperature profile set in a program controller mounted to a discharge plasma machining device, a method for controlling a pulse current also includes a method of setting a pulse current profile.

An example of implementing the discharge plasma machining based on the conventional art will be described. Here, an example of machining will be described which deforms a sample of monocrystal germanium having a diameter of 15 mm and a thickness of 3 mm into a desired shape. FIG. 7 is a conceptual view representing a discharge plasma machining device 901 based on the conventional art.

As shown in FIG. 7, discharge plasma machining device 901 includes a vacuum vessel 1, two punches 2a, 2b opposed to each other in the vertical directions, cylindrical die 3 surrounding punches 2a, 2b, a thermocouple 4, a pulse current generator 6, wires 7a, 7b, and displacing units 8a, 8b. Punches 2a, 2b respectively have a conductivity. Punches 2a, 2b and die 3 are arranged in vacuum vessel 1. Machined item 5 is arranged so as to be sandwiched between two punches 2a, 2b in die 3. Thermocouple 4 has one end arranged to extend into die 3 to measure a temperature of machined item 5 during machining. Punches 2a, 2b are fixed to displacing units 8a, 8b respectively, and displacing units 8a, 8b displace punches 2a, 2b in the vertical directions, respectively. Pulse current generator 6 is electrically connected to punches 2a, 2b through respective wires 7a, 7b. Discharge plasma machining device 901 applies a pressure with respect to machined item 5 through displacement of punches 2a, 2b by means of displacing unit 8a, 8b, and applies a pulse current between punches 2a, 2b from pulse current generator 6 to machine machined item 5.

A sample of monocrystal germanium as machined item 5 was set in discharge plasma machining device 901. While applying a pressure with respect to machined item 5 by means of punches 2a, 2b at 0.6 kN, a pulse current was applied between punches 2a, 2b from pulse current generator 6 so that a temperature measured by thermocouple 4 rises at a rate of 50° C. per minute. A relationship between the temperature detected by thermocouple 4 and a deformed amount of the sample of monocrystal germanium as machined item 5 is shown in FIG. 8. The deformed amount of the sample is presented as a “displaced amount” of punches 2a, 2b.

As shown in FIG. 8, it can be seen that the sample of monocrystal germanium as machined item 5 expands with a rise in the temperature and starts deformation between 460° C. and 480° C. by application of a pressure. However, a temperature at which a machined item starts deformation varies depending on a size of a machined item, a size (diameter) of a punch, a size of a die, and a preheating state of a device. Therefore, in the example of implementing the discharge plasma machining based on the conventional art, the temperature between 560° C. and 630° C., which is 100° C. to 150° C. higher than the temperature at which the sample obtained by the experiment described above starts deformation, is set as a reference machining condition for the case where the machined item is monocrystal germanium.

PTD 1: Japanese Registered Patent No. 4301761

PTD 2: Japanese Patent Laying-Open No. 2000-128648

PTD 3: WO2011/089971

### SUMMARY OF THE INVENTION

In the machining with the discharge plasma machining based on the conventional art, several machining tests are conducted to study a starting temperature of adjoining, sintering, deforming, and the like as well as a time for maintaining a high temperature state to thereby set a machining condition, in other words, a temperature at which the machining is performed. Then, machining is performed under the machining condition set based on the test result. However, depending on a size of a machined item, a size (diameter) of a punch, a size of a die, and a preheating state of a device, there is a possibility that the set machining condition would not be an optimum condition for machining. Therefore, when setting the machining condition, there is a case where the temperature at which the machining is performed is intentionally set to be higher or lower taking into account a size of a machined item, a size (diameter) of a punch, a size of a die, a preheating state of a device, and the like.

However, when the machining temperature of the set machining condition is excessively higher than an optimum temperature for machining, a machined item is machined at an excessively high temperature, so that a quality degradation of the machined item occurs, and the amount of power to be used becomes greater due to a greater loss of energy to be used during machining. Moreover, since the punches and die are also exposed to the temperature higher than the optimum temperature for machining the machined item, the punches and the die are likely to be damaged by a heat load, leading to a shorter product life of the punches and die. Further, since a large vacuum chamber is required, the device becomes larger, leading to an increase in the heat loss and a rise in the cost of the device.

On the other hand, when the machining temperature of the set machining condition is excessively lower than the optimum temperature for machining, the machined item sometimes would not be machined appropriately.

In view of the above, an object of the present invention is to provide a discharge plasma machining device and a method for manufacturing a discharge plasma machined product which avoid an excessively high temperature at the time of machining a machined item and allow an appropriate machining of a machined item.

To accomplish the object described above, a discharge plasma machining device based on the present invention includes a pressing unit configured to apply a pressure with respect to a machined item, a pulse current applying unit configured to apply a pulse current to the machined item, a detection unit configured to detect a spectrum of light of plasma generated by application of the pulse current, and a control unit configured to control the pulse current in accordance with a detection result of the detection unit.

Moreover, a method for manufacturing a discharge plasma machined product based on the present invention includes the steps of starting application of a pressure with respect to a machined item, starting application of a pulse current with respect to the machined item, detecting a spectrum of light of plasma generated by the application of the pulse current, and controlling the pulse current in accordance with a detection result of the step of detecting.

According to the present invention, a control of a pulse current is performed by detecting a spectrum of light of plasma generated during machining, so that machining of a machined item can be performed at an optimum temperature for machining. In other words, an excessively high temperature at the time of machining a machined item can be avoided, and machining of a machined item is performed appropriately.

### BRIEF DESCRIPTION OF THE DRAWINGS

FIG. 1 is a conceptual view representing a discharge plasma machining device in accordance with a first embodiment based on the present invention.

FIG. 2 is an enlarged cross-sectional view representing a vicinity of a machined item in the discharge plasma machining device in accordance with the first embodiment based on the present invention.

FIG. 3 is a graph representing changes in a pressure, a temperature, a current, and a displaced amount in Comparative Example 1.

FIG. 4 is a graph representing changes in a pressure, a temperature, a current, and a displaced amount in Example 1 of the first embodiment based on the present invention.

FIG. 5 is a graph representing changes in a temperature, a current, and a displaced amount in Comparative Example 2.

FIG. 6 is a graph representing changes in a temperature, a current, and a displaced amount in Example 2 of the first embodiment based on the present invention.

FIG. 7 is a conceptual view representing a discharge plasma machining device based on the conventional art.

FIG. 8 is a graph representing a relationship between a temperature detected in a discharge plasma machining device based on the conventional art and deformation of a sample.

### DETAILED DESCRIPTION OF THE PREFERRED EMBODIMENTS

According to the machining with the discharge plasma machining based on the conventional art, in the discharge plasma machining device, a temperature is measured by a thermocouple provided at a die in which a machined item is arranged, and a control of a pulse current is performed based on a measurement result thereof.

The inventors confirmed that, during discharge plasma machining, plasma having a peculiar wavelength under a certain condition occurs to change a physical property of a machined item, and a temperature at which a spectrum of light of plasma occurs and a temperature at which the machined item starts deformation are close to each other. Utilizing this principle, if a control of a pulse current is performed by detecting a spectrum of light of plasma, it becomes possible to perform machining which is not dependent on variable factors such as a size of a machined item, a size (diameter) of a punch, a size of a die, a preheating state of a device, and the like.

In view of the above, according to the present invention, a spectrum of light of plasma generated by application of a pulse current is detected to perform a control of a pulse current.

### First Embodiment

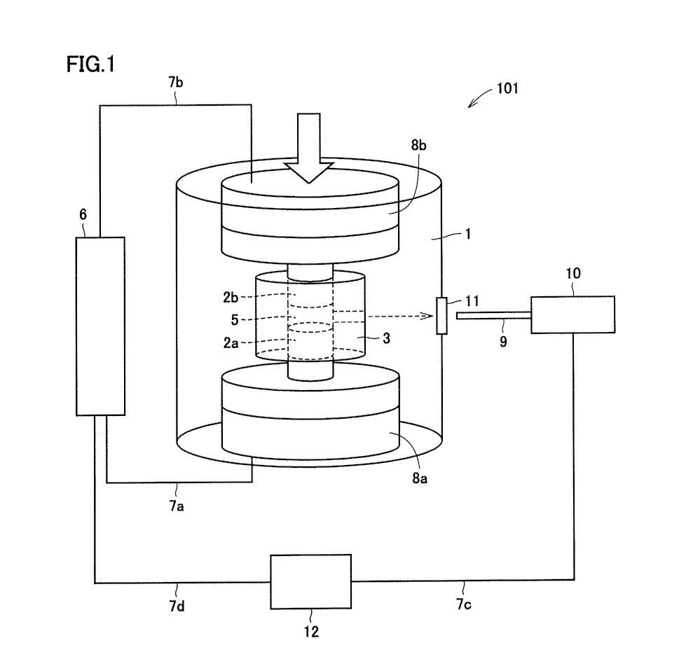

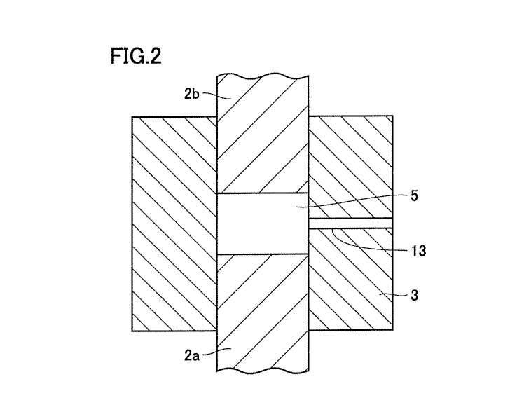

Referring to FIGS. 1 and 2, a discharge plasma machining device 101 according to the first embodiment based on the present invention will be described. FIG. 1 is a conceptual view representing discharge plasma machining device 101 according to the present embodiment. As shown in FIG. 1, discharge plasma machining device 101 according to the present embodiment includes a vacuum vessel 1, two punches 2a, 2b opposed to each other in the vertical directions, a cylindrical die 3, a pulse current generator 6, wires 7a, 7b, 7c, 7d, displacing units 8a, 8b, an optical fiber 9, a spectroscope 10, and a control unit 12.

FIG. 2 is an enlarged cross-sectional view representing a vicinity of a machined item in the discharge plasma machining device 101 according to the present embodiment. Punch 2a, 2b respectively have a conductivity and are columnar. Punches 2a, 2b and die 3 are arranged in vacuum vessel 1. Machined item 5 is arranged so as to be sandwiched between two punches 2a, 2b in die 3.

Die 3 is provided so as to surround machined item 5 arranged between punches 2a, 2b. Die 3 is provided with a through hole 13 connecting a portion of an inner circumferential surface of die 3 opposed to machined item 5 and an outer circumferential surface. In other words, die 3 has an inner surface partially opposed to machined item 5 and an outer surface opposed to the inner surface, and die 3 is provided with through hole 13 connecting the portion of the inner surface opposed to machined item 5 and the outer surface. Therefore, machined item 5 is partially exposed to outside by through hole 13. A diameter of through hole 13 is, for example, about 2 mm.

Punches 2a, 2b are fixed to displacing units 8a, 8b respectively, and displacing unit 8a, 8b displace punches 2a, 2b in the vertical directions, respectively. In discharge plasma machining device 101, displacing units 8a, 8b displace punches 2a, 2b, and punches 2a, 2b apply a pressure with respect to machined item 5. In other words, punches 2a, 2b correspond to a “pressing unit” for applying a pressure with respect to machined item 5.

Pulse current generator 6 is arranged outside of vacuum vessel 1, and electrically connected to punches 2a, 2b through wires 7a, 7b. In discharge plasma machining device 101, a pulse current is applied between punches 2a, 2b from pulse current generator 6. In other words, pulse current generator 6 corresponds to a “pulse current applying unit” for applying a pulse current with respect to machined item 5.

Optical fiber 9 and spectroscope 10 are arranged outside of vacuum vessel 1. Optical fiber 9 is connected to spectroscope 10. Spectroscope 10 is electrically connected to control unit 12 through wire 7c. Control unit 12 is electrically connected to pulse current generator 6 through wire 7d.

Vacuum vessel 1 is provided with a window 11 at a portion opposed to through hole 13 of die 3. Optical fiber 9 is arranged so as to oppose to window 11. Specifically, optical fiber 9 is arranged on an extension of through hole 13 of die 3. Therefore, in the machining of machined item 5 using discharge plasma machining device 101, light of plasma generated in the vicinity of machined item 5 by application of a pulse current between punches 2a, 2b from pulse current generator 6 passes through through-hole 13 and window 11, and is received by optical fiber 9. A spectrum of light of plasma received by optical fiber 9 is detected by spectroscope 10. In other words, spectroscope 10 corresponds to a “detection unit” for detecting a spectrum of light of plasma. A detection result of spectroscope 10 is inputted to control unit 12. Control unit 12 controls a pulse current from pulse current generator 6 based on the detection result of spectroscope 10.

In the present embodiment, since a control of a pulse current is performed by detecting a spectrum of light of plasma generated by application of a pulse current, machining can be performed in a state where the machined item is at an optimum temperature for machining.

Accordingly, since the machined item is not machined at an excessively high temperature, occurrence of the quality degradation of the machined item is prevented. Moreover, since the loss of energy used during the machining becomes smaller, the amount of power to be used can be reduced. Since the punches and die are not exposed to the high temperature, the punches and die are less likely to be damaged by a heat load, so that a product life of the punches and die becomes longer.

In the conventional discharge plasma machining device, since a temperature is measured by means of the thermocouple provided at the die, and a pulse current is controlled based on a measurement result thereof to control a temperature of the die, it has been used based on a concept of a general heating system. However, according to the present invention, since a state of a machined item can be observed through a spectrum of light of plasma, machining can be controlled without depending on the temperature of the die. Since the object of the machining can be accomplished by intensively applying energy required for a machined item in a short period of time, reducing the size of the die to suppress generation of wasteful heat can lessen a space for heat insulation, so that the vacuum vessel can be miniaturized.

According to the present invention, since the size of the vacuum vessel can be reduced, the discharge plasma machining device as a whole becomes smaller, so that the heat loss can be reduced. Moreover, the miniaturization can reduce the cost of the discharge plasma machining device.

As described in the present embodiment, it is preferable that the pressing unit includes two punches 2a, 2b sandwiching machined item 5, and die 3 surrounding two punches 2a, 2b and machined item 5, and that the pulse current applying unit applies a pulse current between two punches 2a, 2b. With this configuration, since application of a pressure and application of a pulse current can be performed with the same member, the number of parts of the device can be suppressed.

As described in the present embodiment, it is preferable that die 3 has the inner surface partially opposed to machined item 5 and the outer surface opposed to the inner surface, and that die 3 is provided with through hole 13 connecting the portion of the inner surface opposed to machined item 5 and the outer surface. With this configuration, straightness of light can be utilized to readily arrange the light-receiving member, in other words, optical fiber 9 or the like.

Moreover, in the case where machined item 5 is powder, it is preferable that die 3 is made of material such as monocrystal silicon, quartz, sapphire, or the like being transparent to infrared light, and that the through hole is not provided. If the through hole is provided in the die in the case where machined item 5 is powder, vacuum drawing in vacuum vessel 1 during machining causes machined item 5 as powder to partially leave the die through the through hole. Therefore, in the case where machined item 5 is powder, it is preferable that die 3 is made of material being transparent to light of plasma generated by application of a pulse current, in other words, made of material such as monocrystal silicon, quartz, sapphire, or the like being transparent to infrared light, and that the through hole is not provided. With this configuration, machining can be performed without any problem even when machined item 5 is powder.

As described in the present embodiment, the detection unit preferably includes optical fiber 9 and spectroscope 10. With this configuration, even when the portion through which light passes is narrow due to the factor such as a small area of the opening of through hole 13, light of plasma generated by applying a pulse current is received by optical fiber 9 and detected by spectroscope 10.

It should be noted that In place of the detection unit including optical fiber 9 and spectroscope 10, the detection unit may be the one including a CCD (Charge Coupled Device) element and a lens filter. Light of plasma which should be detected is the one having a peak of wavelength around 900 nm. Since a generally used CCD element takes light of a wide range of wavelength band as a signal, it cannot detect a specific wavelength. However, with a combination of a filter lens transparent only to light of a wavelength band between 900 nm and 1100 nm and the CCD element can be replaced with the spectroscope. While a spectroscope is generally expensive, the equipment cost can be suppressed if the spectroscope is replaced with the CCD element and lens filter.

The discharge plasma machining device of the present invention may include a heat detection unit such as a thermocouple to measure a temperature in the vicinity of a machined item. A temperature measurement result of the heat detection unit is preferably utilized to detect an abnormal change in a temperature in the vicinity of a machined item. While a discharge plasma machining device based on the conventional art is typically provided with a thermocouple at a die to measure a temperature in the vicinity of a machined item, it is preferable that the present invention includes such a heat detection unit like a thermocouple. With the heat detection unit, when an abnormal change in a temperature occurs, it can be found in an early stage, so that a necessary measure can be taken.

In the following, several examples of actual machining performed by the inventors will be described.

### EXAMPLE 1

Using a discharge plasma machining device which corresponds to discharge plasma machining device 101 shown in FIG. 1 further provided with a heat detection unit, a machine item is arranged between punches 2a, 2b, and the machined item is machined by applying a pulse current while applying a pressure with punches 2a, 2b. It should be noted that the heat detection unit referred here is a thermocouple provided at die 3.

The machined item in the present example is monocrystal germanium (Ge) having a diameter of 14.5 mm and a thickness of 3 mm, and it is deformed into a desired shape. A pulse current was increased at a constant pace starting from a current value of 0. Plasma is not generated immediately after starting application of a pulse current. However, as the current value of the pulse current is increased, plasma is generated at a certain time point. A spectrum of light of plasma generated is detected by means of optical fiber 9 and spectroscope 10. At a time point where the spectrum of light of plasma is detected at first in the course of increasing the current value of the pulse current, the current value of the pulse current at that time point is maintained, and thereafter a pulse current of a constant current value is applied. The application of pressure with respect to the machined item is performed up to 3 kN at a pressure-rising rate of 0.2 kN per minute after 2 minutes from starting of maintaining the current value of the pulse current. The thermocouple provided at die 3 was used for detecting an abnormal rise in temperature in the vicinity of the machined item and an abnormal difference from the program controller.

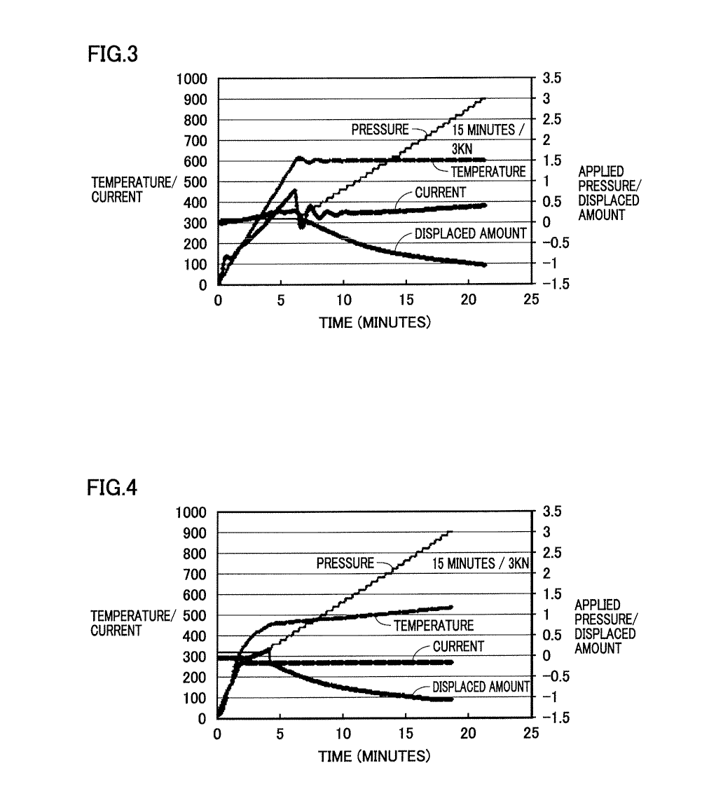

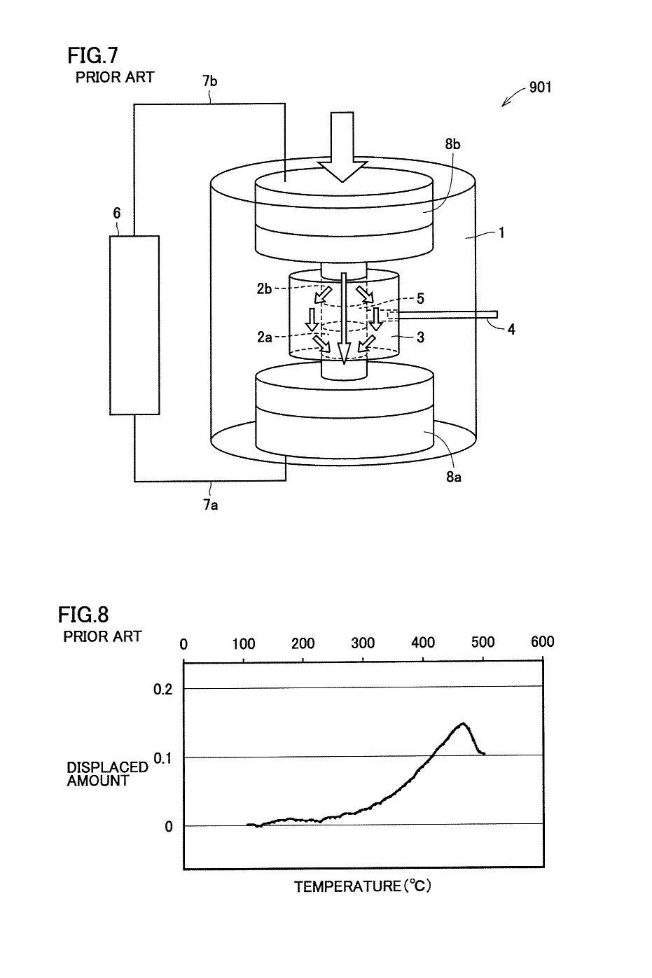

For comparison, Comparative Example 1 is provided which is an example of performing machining with respect to a machined item under the same condition with use of discharge plasma machining device 901 based on the conventional art shown in FIG. 7. FIG. 3 is a graph representing changes in a pressure, a temperature, a current, and a displaced amount in Comparative Example 1. On the other hand, FIG. 4 is a graph representing changes in a pressure, a temperature, a current, and a displaced amount in Example 1.

Example 1 is a method of controlling a pulse current while measuring a temperature of a machined item with a thermocouple during machining, and the temperature was maintained at 600° C. for 15 minutes. Comparing FIG. 3 corresponding to Example 1 with FIG. 4 corresponding to Example 1, it can be seen that, even though the maximum reaching temperature is 530° C. in Example 1, and machining is performed at a temperature lower than Comparative Example 1, the deformed amounts of the machined items of Example 1 and Comparative Example 1 are equal.

According to the conventional art, an atmosphere temperature is considered as a requirement for starting deformation of a machined item, and a temperature measured by means of a thermocouple provided at a die is regarded as the atmosphere temperature. Therefore, a pulse current for raising a temperature and a pulse current for compensating for heat dissipation after reaching the set temperature are required. On the other hand, according to the present invention, generation of a spectrum of light of plasma generated by application of the pulse current is taken as a requirement for starting deformation of a machined item. Therefore, the pulse current may be a constant value. In Example 1 based on the present invention, the power consumption could be reduced by 23.7% as compared to Comparative Example based on the conventional art.

In Example 1 based on the present invention, the machined item was deformed at a temperature between 470° C. and 530° C., thus the machine item could be machined at a temperature 70° C. to 130° C. lower than 600° C. which is the machining temperature of Comparative Example based on the conventional art. This is achieved with a new determination benchmark of detecting a spectrum of light of plasma.

### EXAMPLE 2

Similarly to Example 1, a machined item was machined with use of a discharge plasma machining device which is discharge plasma machining device 101 shown in FIG. 1 further provided with a heat detection unit. The machined item in the present example is powder of barium titanate. This machined item was machined so as to be sintered to have a disk-like shape with a diameter of 15 mm and a thickness of 3 mm.

The powder of barium titanate as the machined item filled a space between punches 2a, 2b, and a pulse current was applied while applying a pressure with respect to the machined item with punches 2a, 2b at a pressure of 40 MPa. The pulse current was increased at a constant pace with a current value starting from 0, similarly to Example 1. Similarly to Example 1, a spectrum of light of plasma generated at a certain time point by application of a pulse current was detected by optical fiber 9 and spectroscope 10, and thereafter a current value of the pulse current at that time point was maintained for 3 minutes. It should be noted that the thermocouple provided at die 3 was used for detection of an abnormal rise in temperature in the vicinity of the machined item and an abnormal difference with the program controller.

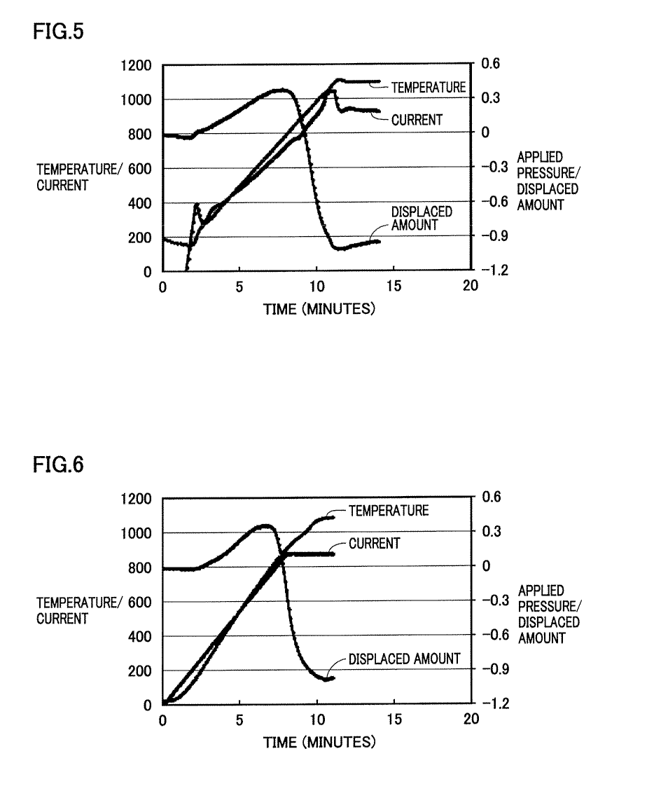

For comparison, Comparative Example 2 is provided which is an example of performing machining with respect to the machined item under the same condition using discharge plasma machining device 901 based on the conventional art shown in FIG. 7. FIG. 5 is a graph representing changes in a pressure, a temperature, a current, and a displaced amount in Comparative Example 2. On the other hand, FIG. 6 is a graph representing changes in a pressure, a temperature, a current, and a displaced amount in Example 2.

Comparative Example 2 is a method of controlling a pulse current while measuring a temperature by means of a thermocouple during machining of the machined item, and it is maintained at 1100° C. for 3 minutes. The profile of the displaced amount is almost close to the expansion/contraction curve. There is no significant difference in the profiles of the displaced amounts between Comparative Example 2 and Example 2. The relative density of the sintered item was 95.4% in Comparative Example and 95.2% in Example 2. In other words, it was found that the present invention can also obtain a product of the same level as the conventional art.

Generally in the sintering of ceramic material, it has been a common knowledge that the item retaining powder such as furnace material like a sagger is considered as being integral and retained at an even temperature. However, the present invention is unconventional to such a common knowledge, and it can obtain the same level of the sintering state as the conventional art by retaining a current value provided at the time point of detecting a spectrum of light of plasma generated by application of the pulse current. In Example 2 based on the present invention, the consumed power could be reduced by 26.6% as compared to Comparative Example 2 based on the conventional art. The result of Example 2 indicates that there is no need to raise a temperature of an item retaining powder more than needed, such as furnace material like a sagger.

### Second Embodiment

A method for manufacturing a discharge plasma machined product in the second embodiment based on the present invention will be described. The method for manufacturing a discharge plasma machined product according to the present invention includes the steps of starting application of a pressure with respect to a machined item, starting application of a pulse current with respect to the machined item, detecting a spectrum of light of plasma generated by the application of the pulse current, and controlling the pulse current based on a detection result from the detecting step.

In the present embodiment, a control of a pulse current is performed by detecting a spectrum of light of plasma generated by the application of the pulse current. Therefore, machining of the machined item can be performed in the state where an optimum temperature for machining is obtained, without an excessively high temperature at the time of machining the machined item. This method for manufacturing can be implemented by the discharge plasma machining device described in the first embodiment.

It is preferable that the method includes the step of arranging the two punches and the machined item in the die so as to sandwich the machined item between the two punches before the step of starting application of a pulse current, and that a pulse current is applied between the two punches in the step of starting application of the pulse current. With this method, the application of a pressure and the application of a pulse current can be performed by means of the same member, so that the number of parts to be used can be suppressed.

It is preferable that the die has an inner surface partially opposed to the machined item and an outer surface opposed to the inner surface, and that a through hole connecting the portion of the inner surface opposed to the machined item and the outer surface are provided. With this method, utilizing straightness of light, a light-receiving member, in other words, an optical fiber or the like can be readily arranged.

It is preferable that the die is made of material transparent to infrared light.

It is preferable that an optical fiber and a spectroscope are used in the step of detecting. With this method, even when the portion through which light passes is narrow, light of plasma generated by the application of the pulse current is received by the optical fiber and detected by the spectroscope.

It is preferable that a CCD element and a filter lens are used in the step of detecting. By employing this method, detection of a specified wavelength can be performed with only an inexpensive equipment.

It is preferable that the method for manufacturing a discharge plasma machined product includes the step of measuring a temperature in the vicinity of the machined item, and that a measurement result obtained from the step of measuring a temperature is utilized for detecting an abnormal change in a temperature in the vicinity of the machined item. With this method, in the case where an abnormal change is present in a temperature in the vicinity of the machined item, it can be found at an early stage, and a necessary measure can be taken.

In each of the embodiments, an example is shown in which the machined item has a columnar shape or a disk-like shape. However, the machined item may have a shape other than the columnar shape or disk-like shape.

It is shown that the surface of the tips of punches 2a, 2b as the pressing unit in contact with the machined item has a flat surface. However, the tip of the pressing unit is not limited to the flat surface. The tips of the pressing unit may have a shape including a desired recess and protrusion.

It should be understood that the embodiments disclosed herein are illustrative and non-restrictive in every respect. The scope of the present invention is defined by the terms of the claims, rather than the description of the embodiments set forth above, and is intended to include any modifications within the scope and meaning equivalent to the terms of the claims.

The present invention can be used for a discharge plasma machining device and a method for manufacturing a discharge plasma machined product.

### REFERENCE SIGN LIST

1 vacuum vessel; 2a, 2b punches; 3 die; 4 thermocouple; 5 machined item; 6 pulse current generator; 7a, 7b wires; 8a, 8b displacing unit; 9 optical fiber; 10 spectroscope; 11 window; 12 control unit; 13 through hole; 101 discharge plasma machining device; 901 discharge plasma machining device (based on conventional art).

1. A discharge plasma machining device, comprising:
a press configured to press a machined item;
a pulse current generator configured to apply a pulse current to said machined item;
a detector configured to detect a spectrum of light of plasma generated by application of said pulse current to said machined item; and
a controller configured to control said pulse current in accordance with a detection result of the detector.

2. The discharge plasma machining device according to claim 1, wherein
said press includes two punches sandwiching said machined item, and a die surrounding said two punches and said machined item, and
said pulse current generator applies said pulse current between said two punches.

3. The discharge plasma machining device according to claim 2, wherein
said die has a first surface partially opposed to said machined item and a second surface opposed to said first surface, and said die defines a through hole connecting a portion of said first surface opposed to said machined item and said second surface.

4. The discharge plasma machining device according to claim 3, wherein said detector detects said spectrum of light of plasma passing through said through hole.

5. The discharge plasma machining device according to claim 2, wherein said die is made of material transparent to infrared light.

6. The discharge plasma machining device according to claim 1, wherein said detector includes an optical fiber and a spectroscope.

7. The discharge plasma machining device according to claim 1, wherein said detector includes a CCD element and a lens filter.

8. The discharge plasma machining device according to claim 1, further comprising a vacuum vessel surrounding said die.

9. The discharge plasma machining device according to claim 8, wherein the vacuum vessel includes a window opposing said through hole.

10. The discharge plasma machining device according to claim 1, further comprising:
a heat detector configured to measure a temperature in a vicinity of said machined item.

11. A method for manufacturing a discharge plasma machined product, the comprising:
applying pressure to a machined item;
applying a pulse current to said machined item;
detecting a spectrum of light of plasma generated by application of said pulse current to said machined item; and
controlling said pulse current in accordance with a detection result of said detection of said spectrum of light of plasma.

12. The method for manufacturing a discharge plasma machined product according to claim 11, further comprising:
arranging two punches and the machined item in a die so that the machined item is sandwiched between the two punches before the application of the pulse current, wherein
in the application of the pulse current, the pulse current is applied between the two punches.

13. The method for manufacturing a discharge plasma machined product according to claim 12, wherein said die has a first surface partially opposed to said machined item and a second surface opposed to said first surface, and said die defines a through hole connecting a portion of said first surface opposed to said machined item and said second surface.

14. The method for manufacturing a discharge plasma machined product according to claim 13, wherein said spectrum of light of plasma passes through said through hole and is detected.

15. The method for manufacturing a discharge plasma machined product according to claim 12, wherein said die is made of material transparent to infrared light.

16. The method for manufacturing a discharge plasma machined product according to claim 11, wherein said detecting is conducted using an optical fiber and a spectroscope.

17. The method for manufacturing a discharge plasma machined product according to claim 11, wherein said detecting is conducted using a CCD element and a filter lens.

18. The method for manufacturing a discharge plasma machined product according to claim 11, wherein a vacuum vessel surrounds said die, the vacuum vessel including a window opposing said through hole, wherein said spectrum of light of plasma passes through said through hole and said window and is detected.

19. The method for manufacturing a discharge plasma machined product according to claim 11, further comprising:
measuring a temperature in a vicinity of said machined item, wherein
a measurement result in accordance with said measured temperature is used for detecting an abnormal change in temperature in a vicinity of said machined item.
